(19) United States
(12) Patent Application Publication
(10) Pub. No.: US 2013/0119218 A1
(43) Pub. Date: May 16, 2013

(54) TURNABLE WALL MOUNT FOR DISPLAY

(71) Applicant: Petter Åstradsson, Vaxholm (SE)

(72) Inventor: Petter Åstradsson, Vaxholm (SE)

(73) Assignee: SMS SMART MEDIA SOLUTIONS AB, Nacka (SE)

(21) Appl. No.: 13/812,238

(22) PCT Filed: Aug. 11, 2011
(86) PCT No.: PCT/SE2011/050993

§ 371 Date: Jan. 25, 2013

(30) Foreign Application Priority Data
Aug. 23, 2010 (SE) 1000856-3

(51) Int. Cl. F16M 13/02

(52) U.S. Cl. CPC F16M 13/02
USPC 248/274.1

(57) ABSTRACT

A display mount (1) comprising a first device to be fastened on a mounting surface is described. The display mount comprises a second device to be fastened to a display (8) and an arm (10). A first end (11) of the arm (10) is rotatably arm ranged on the first device and a second end (13) of the arm (10) is rotatably arranged on the second device. The first device comprises a first bracket (5) and the second device comprises a second bracket (5) to be attached to the display (8) and sleds (9) which are slidably arranged on the second bracket (5). The second end (13) of the arm (10) is rotatably arranged on the sleds (9). In a folded state the display mount (1) has the display (8) close to and essentially parallel to the mounting surface.

### TECHNICAL FIELD

The present invention relates to a display mount for mounting of a display on a vertical surface such as a wall. More specifically the present invention relates to a display mount which provides possibilities to angle the display in relation to the vertical surface.

### DESCRIPTION OF THE PRIOR ART

Flat panel monitors and televisions are used extensively in commercial, residential and business environments. These flat panel displays enable an enhanced viewing experience and provide numerous advantages over the prior CRT monitors and TV's, of which the space savings is the most obvious advantage. Flat panel monitors may be mounted on a surface, such as a wall, a column, a post or a flat surface on a piece of furniture. A display mount is used to mount the display on the surface. It is advantageous if the display may be angled in relation to the surface on which the display is mounted. To this end the mount may be provided with a first device to be fastened on a mounting surface, a second device to be fastened to a display, and an arm, wherein a first end of the arm is rotatably arranged on the first device and a second end of the arm is rotatably arranged on the second device. With such a mount the display may be moved from a position close to the mounting surface and essentially parallel to the mounting surface to a position at a distance from the mounting surface. In order to allow the display to be angled at an arbitrary angle in relation to the surface, the arm has to be longer than half the width of the display. To avoid that the arm is visible when the display is positioned in the position close to the mounting surface the arm on such mounts is usually made with a hinge so that the arm is folded in the position close to the mounting surface.

DE 20 206 013 179 describes a display mount comprising a wall bracket to be mounted on a wall and a display bracket to be mounted on a display. A foldable arm is arranged between the wall bracket and the display bracket. The wall mount comprises two rails on which the arm is attached movable along the rails.

The PCT application WO 2009/152054 describes a mount for moving a display. The mount comprises a casing to be attached to a surface such as a wall. The mount also comprises a motor and a gear that make one or more axles with attached arms to move in a linear manner along longer sides coupled to the casing and, simultaneously, rotate during linear relocation. At the ends of the arms a display bracket is arranged.

Due to the decreasing thickness of displays on the market the demand for thinner display mounts have increased. It is not possible to provide a thin display mount by only decreasing the thickness of the mounts of the present design as it would not be possible to achieve the necessary strength and stability of such a display mount.

### SUMMARY OF THE INVENTION

An object of the present invention is to provide a display mount, which may be made thinner than the display mounts according to the prior art.

Another object of the present invention is to provide a thin display mount which allows the display to be angled at an arbitrary angle in relation to the surface on which the display mount is arranged which is less complicated than the display mounts according to the prior art.

A further object of the present invention is to provide a thin display mount which allows the display to be angled at an arbitrary angle in relation to the mounting surface on which the display mount is arranged in which the arm may be completely hidden behind the display in the position of the mount in which the display is closest to the mounting surface.

At least one of the above objects are fulfilled with a display mount according to claim 1.

Further advantages of the invention are provided with the features of the dependent claims.

A display mount according to the invention comprises a first device to be fastened on a mounting surface, a second device to be fastened on a display, and an arm. A first end of the arm is rotatably arranged on the first device and a second end of the arm is rotatably arranged on the second device. The display mount is characterized in that the first device comprises a first bracket to be attached to a mounting surface and that the second device comprises a second bracket to be attached to the display and at least one sled which is slidably arranged on the second bracket. The second end of the arm is rotatably arranged on the sled, wherein the display mount in a folded state has the display close to and essentially parallel to the mounting surface.

A display mount according to the invention enables the provision of a very thin display mount. The thickness of the display mount may be as thin as the thickness of the arm. Due to the slidability of the sled on the second bracket the attachment point of the arm in the sled may be moved in relation to the display. Thus, the arm may be considerably shorter compared to the arm on display mounts according to the prior art. A shorter arm may be made thinner than the arms according to the prior art. Furthermore, as the arm may be made considerably shorter than the arms according to the prior art the arm is easily hidden behind the display even when the arm is not foldable. A non-foldable arm is less complicated than a foldable arm.

Thus, the arm may be a rigid arm. It is of course possible to have the arm foldable, but as that is a more complicated, and thus also a more expensive solution, it is preferable to have the arm rigid.

The second bracket may comprise at least one rail on which the at least one sled is arranged. The second bracket may comprise more than one rail and preferably the second bracket comprises two parallel rails with one sled arranged on each one of the rails.

In the folded state of the display mount the first device may be in engagement with the second device. By the first device being able to be in engagement with the second device the display may be secured in the position close to the wall.

The first device may be arranged to engage with the second device through snap action. Engagement through snap action is a well known principle and may easily be implemented by a man skilled in the art.

The first device may comprise a first profile and a second profile arranged in parallel to the first profile, wherein the arm is hinged between the first profile and the second profile and wherein the arm in the folded state of the display mount is arranged between the first profile and the second profile. Such an arrangement of the arm provides for a sturdy and stable display mount.

In the following preferred embodiments of the invention will be described with reference to the appended drawings.

### SHORT DESCRIPTION OF THE DRAWINGS

FIG. 1 is a perspective front view of a display mount according to an embodiment of the present invention.

FIG. 2 is a perspective front view of the display mount of FIG. 1 in a second position of the display mount.

FIG. 3 is a perspective front view of the display mount of FIGS. 1 and 2 in a state where the display is at a distance from the mounting surface.

FIG. 4 is a perspective front view in which the display has been angled in relation to the position of the display in FIG. 3.

FIG. 5 is an exploded view of the display mount in FIGS. 1-4.

### DESCRIPTION OF PREFERRED EMBODIMENTS OF THE INVENTION

In the following description of preferred embodiments of the invention similar elements or features in different figures will be denoted with the same reference numeral. It is to be noted that the drawings are not drawn to scale.

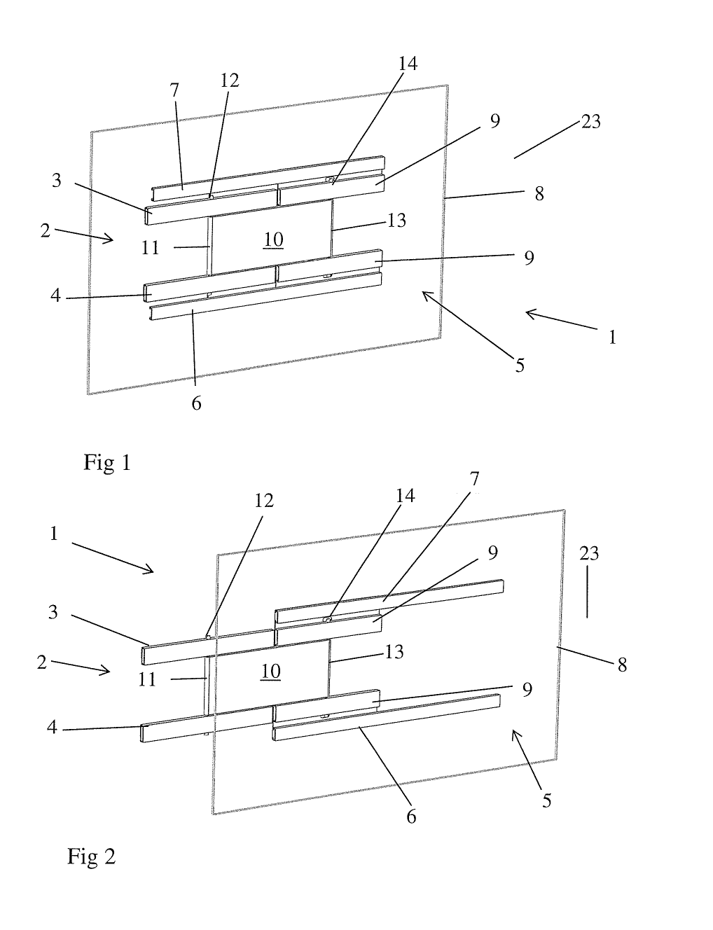

FIG. 1 is a perspective front view of a display mount 1 according to an embodiment of the present invention. The display mount 1 comprises a first device comprising a first bracket 2 in the form of two profiles 3, 4, to be fastened on a mounting surface 23. The display mount also comprises a second device comprising a second bracket 5 in the form of two parallel rails 6, 7, to be attached to the display 8 and sleds 9 which are slidably arranged on the rails 6, 7, of the second bracket. The display mount also comprises a rigid arm 10 which is arranged between the first bracket 2 and the second bracket 5. A first end 11 of the arm 10 is rotatably arranged on the first bracket 2 by means of a first axle 12 which is arranged through the two profiles 3, 4, of the first bracket 2 and through the arm 10. A second end 13 of the arm 10 is rotatably arranged on the second device 5 by means of a second axle 14 which is arranged through the sleds 9 and through the arm 10. In a folded state of the display mount 1 the display 8 is close to and essentially parallel to the mounting surface 23.

The rails 6, 7, may be arranged on two vertical bars. The distance between the rails may be adjusted by adjustment of the position of the rails 6, 7, on the vertical bars. In the folded state the first bracket 2 is arranged to engage the second bracket 5 through snap action. In this way the display is locked in place in the folded state.

FIG. 2 is a perspective front view of the display mount of FIG. 1 in a second position of the display mount. In the position shown in FIG. 2 the sleds 9 have been moved in relation to the rails 6, 7, so that the display is further to the right in FIG. 2.

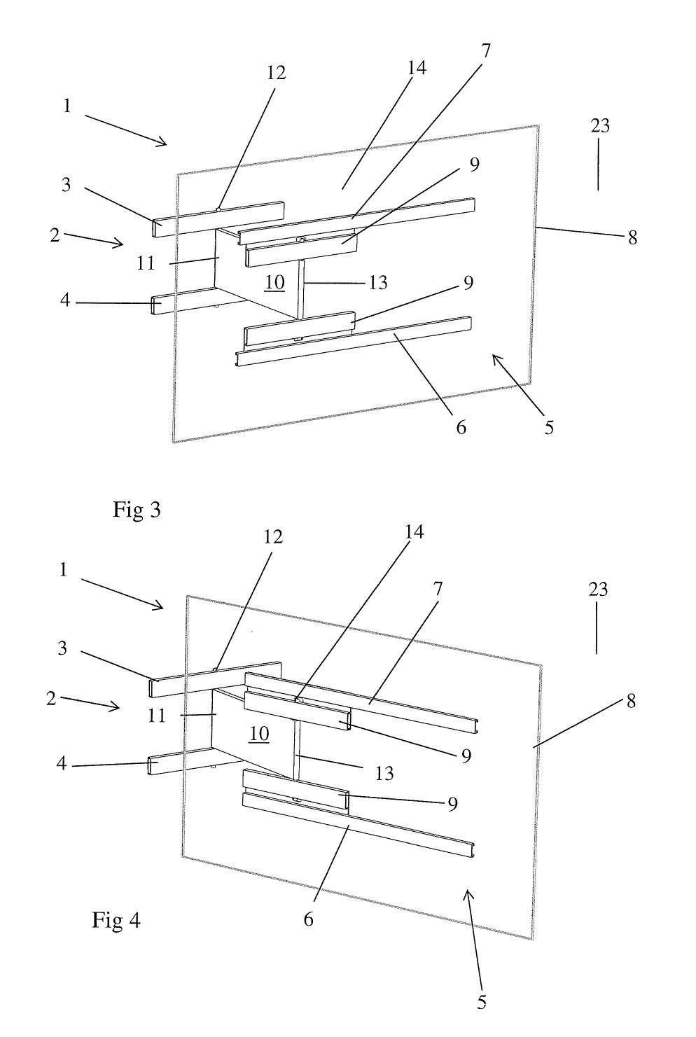

FIG. 3 is a perspective front view of the display mount of FIGS. 1 and 2 in a position where the display is at a distance from the mounting surface but still essentially parallel to the mounting surface. This has been achieved by rotating the arm 10 in relation to the first bracket 2 as well as the sleds 9, and thus also the second bracket 5 and the display 10.

FIG. 4 is a perspective front view in which the display has been angled in relation to the position of the display in FIG. 3. This position has been achieved by rotation of the sleds, and thus also the display 10 around the second axle 14.

It is possible to slide the sleds 9 in relation to the rails 6, 7, to the other side and to angle the display in the other direction. This gives the user large freedom to angle the display at an arbitrary angle.

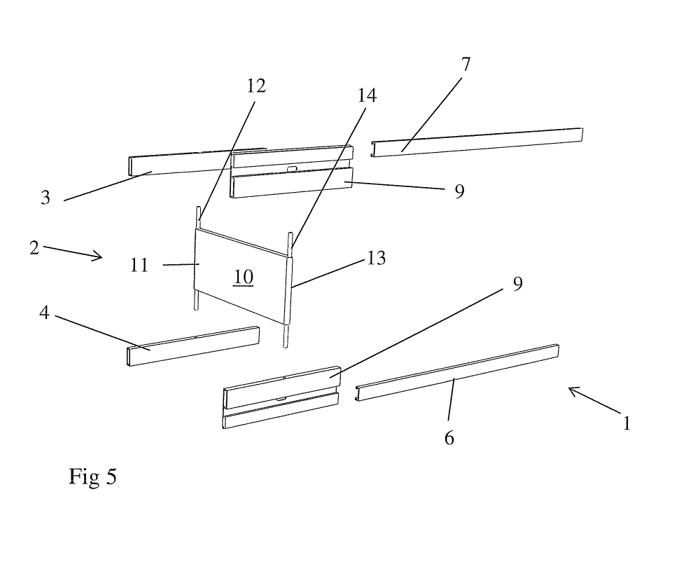

FIG. 5 is an exploded view of the display mount of FIGS. 1-4. In FIG. 5 the first axle 12 and the second axle 14 are shown attached to the arm 10. However, the axles 12, 14 may be detachable from the arm 10.

The described embodiments may be modified in many ways without departing from the spirit and scope of the present invention which is limited only by the appended claims.

It is of course possible to have any number of rails and sleds, such as one or three.

The arm 10 may be moved and rotated symmetrically in relation to the wall.

1. A display mount (1), comprising a first device to be fastened on a mounting surface (23), a second device to be fastened to a display (8), and an arm (10), wherein a first end (11) of the arm (10) is rotatably arranged on the first device and a second end (13) of the arm is rotatably arranged on the second device, characterized in that the first device comprises a first bracket (2) to be attached to the mounting surface (23) and that the second device comprises a second bracket (5) to be attached to the display (8) and at least one sled (9) which is slidably arranged on the second bracket (5), wherein the second end (13) of the arm (10) is rotatably arranged on the at least one sled (9), wherein the display mount (1) in a folded state has the display (8) close to and essentially parallel to the mounting surface (23).

2. The display mount (1) according to claim 1 , wherein the arm (10) is a rigid arm.

3. The display mount (1) according to claim 1, wherein the second bracket (5) comprises at least one rail (6, 7) on which the at least one sled (9) is arranged.

4. The display mount (1) according to claim 3, wherein the second bracket (5) comprises two parallel rails (6, 7).

5. The display mount (1) according to claim 1, wherein, in the folded state, the first device is in engagement with the second device.

6. The display mount (1) according to claim 5, wherein the first device engages with the second device through snap action.

7. The display mount (1) according to claim 1, wherein the first device comprises a first profile (3) and a second profile (4) arranged in parallel to the first profile (3), wherein the arm (10) is hinged between the first profile (3) and the second profile (4) and wherein the arm (10) in the folded state of the display mount (1) is arranged between the first profile (3) and the second profile (4).
